(19) United States
(12) Patent Application Publication
(10) Pub. No.: US 2025/0262819 A1
(43) Pub. Date: Aug. 21, 2025

(54) 3D PRINTING MULTIPLE OBJECTS

(71) Applicant: International Business Machines Corporation, Armonk, NY (US)

(72) Inventors: Gwilym Benjamin Lee Newton, Winchester (GB); Elizabeth Jane Maple, Basingstoke (GB); Daniel Thomas Cunnington, Corbridge (GB)

(21) Appl. No.: 18/581,803

(22) Filed: Feb. 20, 2024

(51) Int. Cl. B29C 64/171; B29C 64/393; B33Y 50/02

(52) U.S. Cl. CPC B29C 64/171; B29C 64/393; B33Y 50/02

(57) ABSTRACT

Three-dimensionally (3D) printing a plurality of objects by storing a set of candidate print-bed locations for each object of a plurality of objects, initializing printing of each object of the plurality of objects, detecting a printing failure for a first object of the plurality of objects, pausing the printing of the first object, identifying a first print-bed location for a new object from the set of candidate print bed locations, modifying print code adding instructions to print the new object at the first print-bed location, and printing the new object at the first print-bed location.

### FIELD OF THE INVENTION

The disclosure relates generally to the three-dimensional (3D) printing of multiple objects. The invention relates particularly to the concurrent three-dimensional printing of multiple objects.

### BACKGROUND

Automated manufacturing tools such as 3D printers and CNC machines are increasingly being adopted by industry. Many prints have to be discarded due to minor printing errors. Prevention requires time consuming monitoring by human experts which also limits the achievable level of automation.

### SUMMARY

The following presents a summary to provide a basic understanding of one or more embodiments of the disclosure. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatuses and/or computer program products enable 3D printing of a plurality of objects.

Aspects of the invention disclose methods, systems and computer readable media associated with 3D printing a plurality of objects by storing a set of candidate print-bed locations for each object of a plurality of objects, initializing printing of each object of the plurality of objects, detecting a printing failure for a first object of the plurality of objects, pausing the printing of the first object, identifying a first print-bed location for a new object from the set of candidate print bed locations, modifying print code adding instructions to print the new object at the first print-bed location, and printing the new object at the first print-bed location.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 provides a schematic illustration of a system for an embodiment of the invention.

FIG. 2 provides a schematic illustration of object locations on a print-bed.

FIG. 3 provides a schematic illustration of functional components of an embodiment of the invention.

FIG. 4 provides a schematic illustration of functional steps of an embodiment of the invention.

FIG. 5 provides a technical sequence for an embodiment of the invention.

FIG. 6 provides a flowchart depicting an operational sequence, according to an embodiment of the invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

As used herein, print-bed, refers to a flat surface onto which objects are printed by a 3D printer. The print-bed may be movable.

As used herein, print-head, refers to a mechanical nozzle from which a printer dispenses printing material. The print-head may also be movable.

As used herein, extruding, refers to the process of dispensing material from the print head.

As used herein, G-code, refers to the machine-level instructions required to print an object. Such G-code instructions translate into actions such as move the print-head to location (X,Y), extrude Z amount of material.

As used herein, slicer, refers to software which can convert a provided 3D model into executable G-code instructions.

When multiple objects are being printed at the same time print reliability presents an issue in that a single print object failure can affect the print quality of other concurrently printed objects in addition to the print output quantity. 3D printers often print one layer at a time in the X and Y dimensions for each repetition of an object, instead of printing each object in full in a sequential manner, in order to prevent collisions with the print head. A sequential printing approach would limit the size of objects that could be printed. Therefore, printers print the nth layer of each object across all objects prior to printing layer n+1 for each object.

An error printing a single object in a layer-by-layer printing method could potentially disrupt the entire print. For example, if one object fails to print to the desired level of structural integrity, it may collapse and disrupt another object. Also, one object could become loose from the print bed, potentially interfering with the other objects if printing were to continue in full. Disclosed embodiments present a solution to increase the likelihood of obtaining all of the objects in a multi-object print by utilizing additional space on the print bed in the case of individual object failure. This increases the reliability of the printer cycle, and therefore the level of automation, reducing the likelihood of a (time-consuming) full restart, and reducing material waste. Even for the case where an individual object fails but does not disrupt the entire print, the print cycle fails to yield the desired output and a user must monitor the printing and restart printing as needed, often after the full print has finished. Disclosed methods dynamically modify the machine-level printer instructions to create additional copies of an object in the event of a single object failure, by maximizing the use of available space on the print bed.

In one embodiment, the method proceeds as follows: a user desires the printing of three copies of an object A, denoted as A1, A2, and A3. The print of A1 has failed as detected using one or more cameras, or using others print-fault detections methods known in the art. Either prior to the initialization of the printing of A1, A2, and A3, or after detecting the failure of A1, the slicer calculates all possible print-bed locations for an object A. Methods store these possible print-bed locations in a data storage element, such as a system memory location associated with the printer or an external controller such as a raspberry pi controller linked to the 3D printer controller. In this embodiment, the slider evaluates each possible location for a new print, A4, using a sequence of criteria. The priority order of the criteria sequence may be provided by default or may be set or altered by a user. Such criteria may include: minimizing overall print cycle time, preventing the possibility of a printhead collision with any of the existing objects or the new object, or randomly selecting a location from the stored location.

After print failure detection, the method stops all printing actions, not only for A1, but also the activities for A2, and A3. The method then identifies one of the previously stored print-bed locations using the criteria. The method determines an offset for the new print location and revises the current G-code for A1-A3 to remove the offset for A1 and to add the offset for the new A4 location. The method then resumes printing, beginning with the printing of A4. The method prints layers of A4 until the layer where printing A2, and A3, paused. The method then resumes printing A2 and A3, now printing layers of A2, A3, and A4, until the last layer of each of A2-A4, has printed.

In this embodiment, if the method detects additional print failures after beginning the printing of A4, methods follow the steps above with the faulty printing being replaced with a new printing at a new stored location after determining the correct offset for the new location. For instances where print failures occur and all stored locations have been utilized before completing the printing of the objects, printing stops.

Exemplary embodiments replace a failed print with a good print such that the print cycle yields the desired number of printed objects. Further the failing print does not affect the printing of other objects in the print cycle.

By pausing the printing of all objects at a designated current layer, printing the new object alone until reaching the current layer, and then resuming the printing of the paused objects other than the failed print object, methods integrate the printing of the replacement object into the overall print sequence for the entire set of secured objects.

By defining an offset for each print-bed location, disabling the offset for the failed print, and enabling the offset for the new object, methods provide a clear manner of organizing the printing of the original and new objects after detecting failures.

By determining a maximum number of print-bed locations for an object, receiving user input a quantity of objects in the plurality of objects, and providing a number of print-bed locations equal to the quantity, methods provide a basis for identifying a location for a new object after a print failure has been detected. By printing the new object until the current layer equals a last layer, methods ensure that the printing of the new object completes.

In one embodiment, methods select an initial print-bed location for an initial object of the plurality of objects, define an offset from the initial print-bed location for each object of the plurality other than the initial object, and initialize the printing of each object of the plurality of objects according to the initial print-bed locations and the offsets. These steps provide a framework for identifying the respective print objects, thereby enabling the addition of a new object after the detection of a print failure in one of the initial objects.

By identifying the first print-bed location according to a criteria selected from a list consisting of: location will not cause a print-head collision, location will minimize print time, or a methods select a location randomly, particularly when multiple locations satisfy all other criteria, methods provide efficiency in the criteria used for selecting a location on the print-bed for the new object.

Aspects of the present invention relate generally to 3D printing systems and, more particularly, to printing multiple objects at one time. In embodiments, a system stores a set of candidate print-bed locations for each object of a plurality of objects, initializes printing of each object of the plurality of objects, detects a printing failure for a first object of the plurality of objects, pauses the printing of the first object, identifies a first print-bed location for a new object from the set of candidate print bed locations, modifies print code adding instructions to print a new object at the first print-bed location, and prints the new object at the first print-bed location.

According to aspects of the invention, the system automatically and dynamically detects failed printing conditions and adapt the overall printing sequence to adjust to the failed printing. The overall sequence yields the desired number of objects despite printing failures.

In accordance with aspects of the invention methods automatically adapt a printing sequence to deal with detected printing failures. The adaptable system stores a set of candidate print-bed locations for each object of a plurality of objects, initializes printing of each object of the plurality of objects, detects a printing failure for a first object of the plurality of objects, pauses the printing of the first object, identifies a first print-bed location for a new object from the set of candidate print bed locations, modifies print code adding instructions to print a new object at the first print-bed location, and prints the new object at the first print-bed location.

Aspects of the invention provide an improvement in the technical field of 3D printing systems and methods. Conventional 3D printing systems stop at print failures, or continue printing in spite of failures, thereby compounding the failure related problems. Disclosed systems and methods improve performance. The improved system stores a set of candidate print-bed locations for each object of a plurality of objects, initializes printing of each object of the plurality of objects, detects a printing failure for a first object of the plurality of objects, pauses the printing of the first object, identifies a first print-bed location for a new object from the set of candidate print bed locations, modifies print code adding instructions to print a new object at the first print-bed location, and prints the new object at the first print-bed location.

Aspects of the invention also provide an improvement to computer functionality. In particular, implementations of the invention provided a specific improvement to the way 3D printing systems operate, embodied in the adaptation of the system to address print failures and to print replacement objects such that each print run yields the desired quantity of objects despite object print failures.

In an embodiment, one or more components of the system can employ hardware and/or software to solve highly technical problems (e.g., reliably printing a plurality of object, etc.). Humans lack the mental capabilities necessary to facilitate the processing and 3D printing of a group of objects in the face of print errors. Further, some of the processes performed may be performed by a specialized computer for carrying out defined tasks related to 3D printing operations. For example, a specialized computer can be employed to carry out tasks related to improving 3D printing reliability or the like.

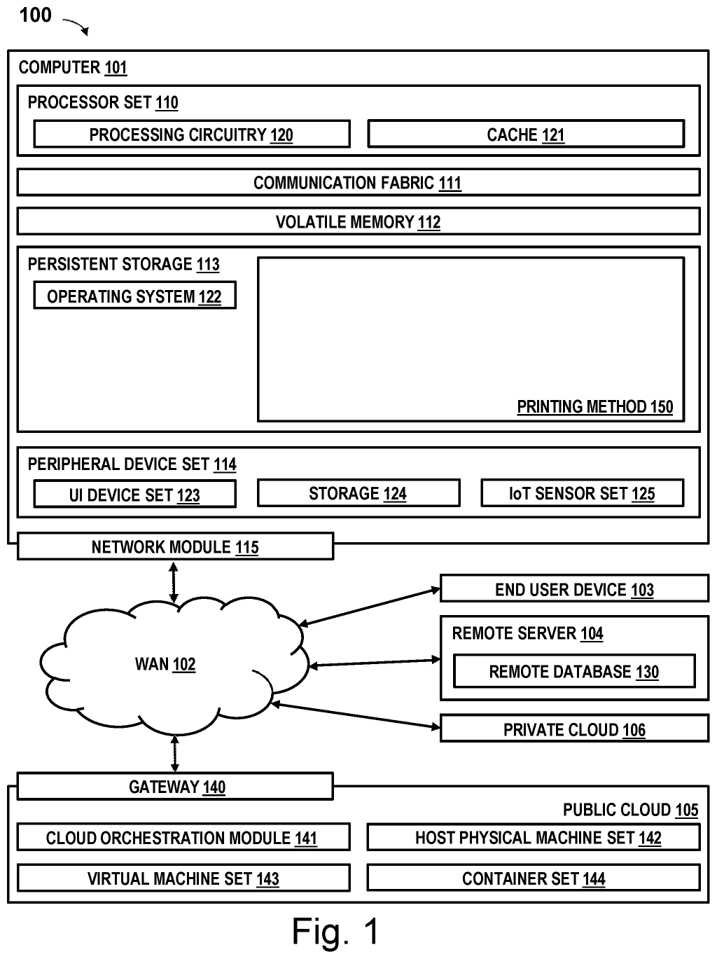

As shown in FIG. 1, computing environment 100 contains an example of an environment for the execution of at least some of the computer code involved in performing the inventive methods, such as printing improvement method 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

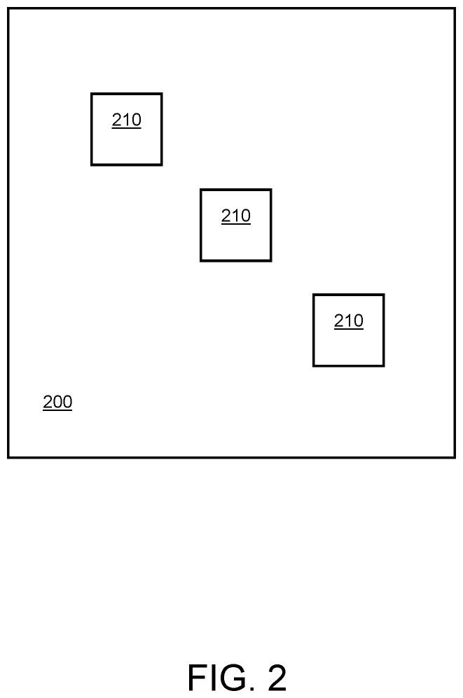

FIG. 2 illustrates placement of three print objects 210, upon print-bed 200.

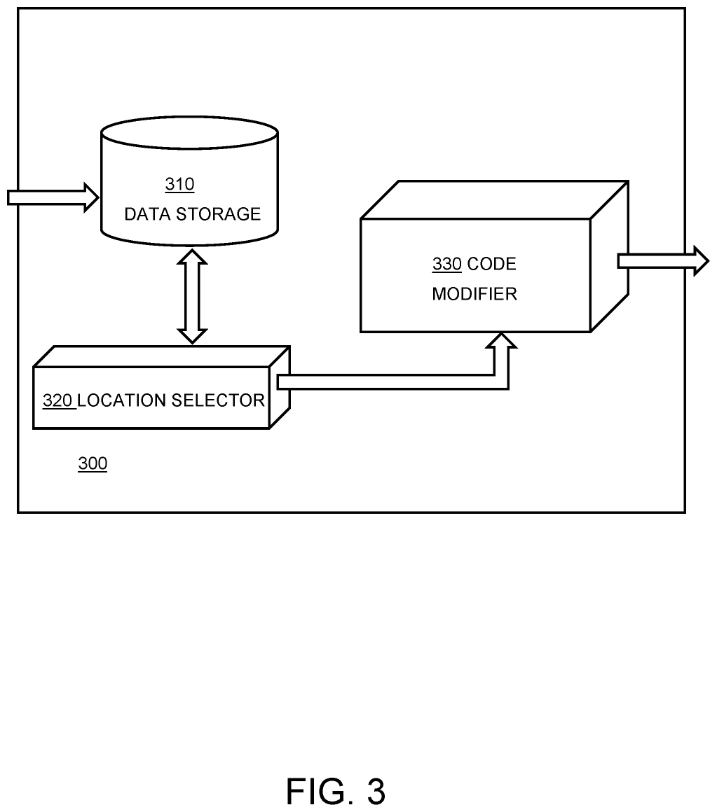

FIG. 3 illustrates functional system components according to an embodiment of the invention. As shown in the figure, an exemplary system 300 includes three main components; Data Storage 310, which stores possible locations on the print-bed where objects could be printed, a Location Selector 320, which chooses one of these locations based on a set of criteria, and a G-code modifier and relative offset calculator 330, which dynamically modifies the G-code to adjust the print in real-time to enable object printing at a new location. Let us now describe an embodiment of each of these components.

Data storage 310, follows standard data storage techniques. Possible print locations can be obtained from the slicer. In one embodiment, the method modifies the slicer component to expose these print locations not already exposed via an API. The possible locations can be stored in a database as geometry information (e.g., a starting X,Y,Z coordinate and an object ID, or a polygon of coordinates in GeoJSON format).

The location selector 320, retrieves possible locations from the data storage and evaluates each location against a set of constraints. In an embodiment the location chosen must not collide with the print-head or other objects and should also minimize the print time. In practice methods choose other constraints depending on the use-case. In one embodiment, methods implement the component by a brute-force technique that evaluates each candidate location, eliminating a location that violates the constraints (or in the case of time minimization, does not minimize the appropriate metric). If there are multiple optimal locations remaining following pruning, a candidate location is chosen at random from the set of optimal locations.

Once a new location has been identified, method modify the G-code to ensure printing of a replacement object at the new location. In one embodiment, methods calculate a relative offset (i.e., methods utilize the original G-code associated with a given object but apply relative offset to change the location to the new location identified). Embodiments utilize the relative offset and original G-code to perform the print, pausing and starting the printing of objects accordingly.

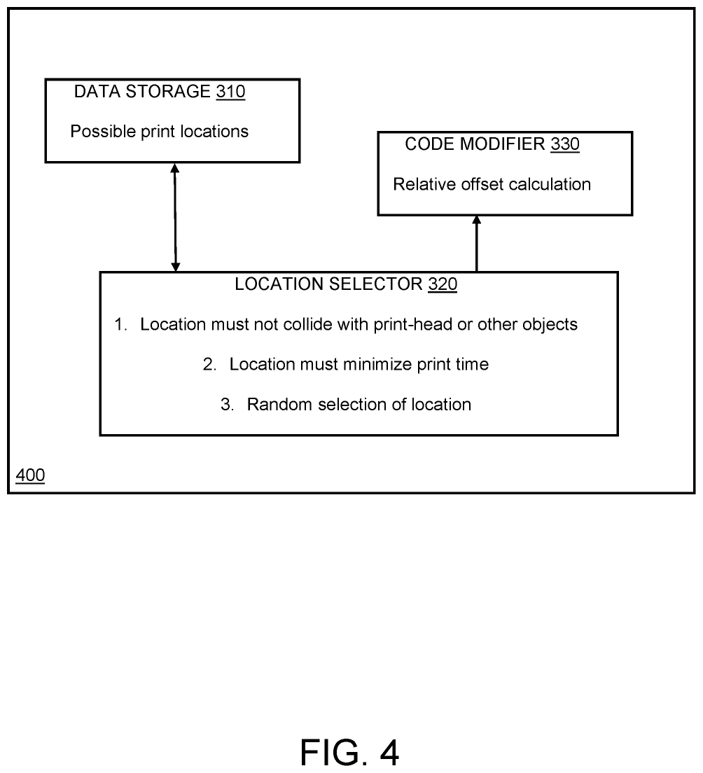

FIG. 4 provides a schematic illustration 400 of the functional aspects of Data storage 310, Location selector 320, and G-code modifier 330 as part of system 300. Data storage 310 includes multiple candidate print-bed locations for desired objects. Location selector 320 includes criteria for selecting a new print-bed location from the candidate locations, as necessary. Code modifier 330, provides updated print code as methods address print failures through adding new print-bed locations.

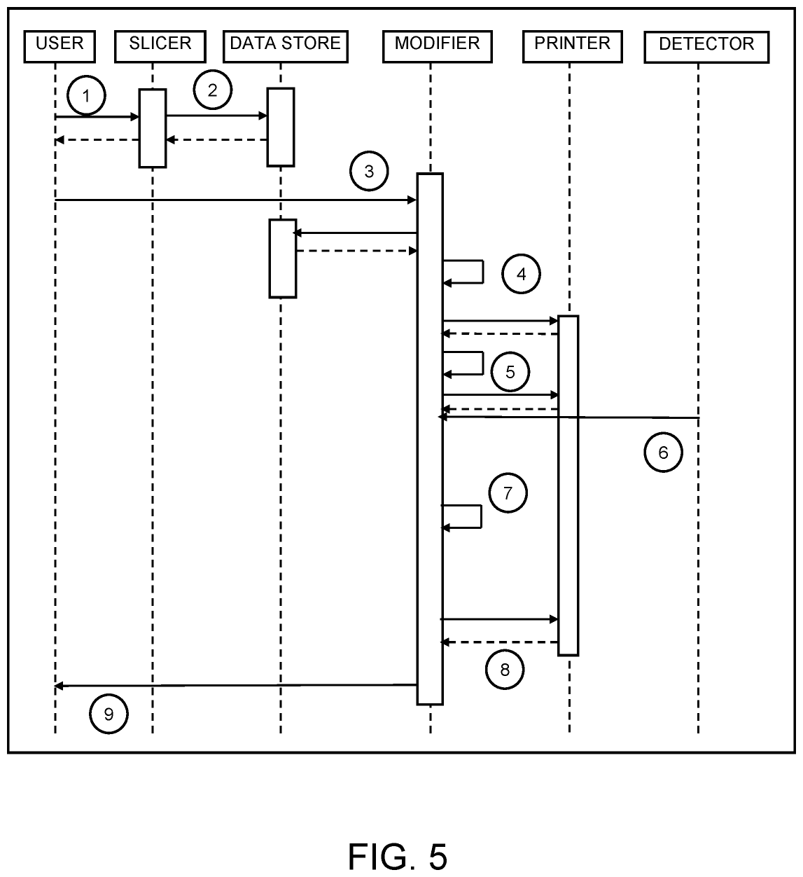

FIG. 5 provides a schematic technical sequence 500 of the steps of exemplary embodiments. As shown in the Figure: at 1, the user adds an object (OBJ) to the slicer software and requests a number of instances (Ix) of this to be printed. The slicer software replicates the object across the bed a maximum number of times, working out the MAX-I possible to fit on the bed. Methods then store possible locations in the data storage component of the invention.

At 2, the method generates and stores the G-code to print a single instance of the object relative to some <X, Y> point, the method stores this as the RELATIVE_INSTANCE_GCODE. It also stores the coordinates for each of the replicated objects from step 1 as a list of offsets from this relative <X,Y> position as OFFSET_LIST.

At 3, the user requests the printer to print x instances of the object (In one embodiment, this a raspberry pi device or similar that is connected to the printer and runs the code receives this input from the user).

At 4, the G-code modifier, on A raspberry pi for example, requests the RELATIVE_INSTANCE_GCODE and OFFSET_LIST from data storage. Initially, methods allow the slicer to choose appropriate printing locations for each object, following the existing process. Methods store these locations using the data storage component alongside a list of the offsets currently set to print (ENABLED_OFFSETS). It also stores a LAST_LAYER_TO_PRINT variable which indicates the number of the final layer of G-code to complete the printing of the object.

At 5, during normal function, the printer: a) sets CURRENT_LAYER to 0 to signify the start of the print, b) cycles through each of the enabled offsets in the ENABLED_OFFSETS list, moving the print head to the <X, Y> location before, c) executes all the G-code in the RELATIVE_INSTANCE_GCODE for that layer, and d) increments CURRENT_LAYER to signify the end of that layer of printing and the need to start the next. Methods repeat steps c and d until CURRENT_LAYER=LAST_LAYER_TO_PRINT, whereby the print completes.

At 6, an error detection module notifies the method after detecting an error. The module provides the position on the print of the failure point. Print fault detection modules, as are known in the art, may be integrated into a printing system including a control module, a print module and the fault detection module,

At 7, methods identify the failed print using the details for the detected error. Methods remove the offset for the failed print from the ENABLED_OFFSETS list. The methods store the CURRENT_LAYER variable as the RESUME_LAYER, as a record of where to start all prints again once the replacement print starts. Using the same process as described in above, methods calculate and store the best print location for a replacement object to be printed in the ENABLED_OFFSETS list, as well as in a variable REPLACEMENT_OBJECT. The G-code modifier then uses this information to print layers 0 to RESUME_LAYER of the REPLACEMENT_OBJECT using the RELATIVE_INSTANCE_GCODE, thereby replacing the failed print with another print at a different location on the print bed, stopping as soon as it reaches the height at which the original print was deemed to have failed.

At 8, once the CURRENT_LAYER variable matches the RESUME_LAYER variable, methods return to normal print function, and cycle through each of the enabled offsets in the ENABLED_OFFSETS list and execute the G-code in the RELATIVE_INSTANCE_GCODE for that layer. Resulting in all prints on the bed continuing from this point.

At 9, once CURRENT_LAYER=LAST_LAYER_TO_PRINT, methods have finished printing all instances of the object, and the user is notified that the printing has ended.

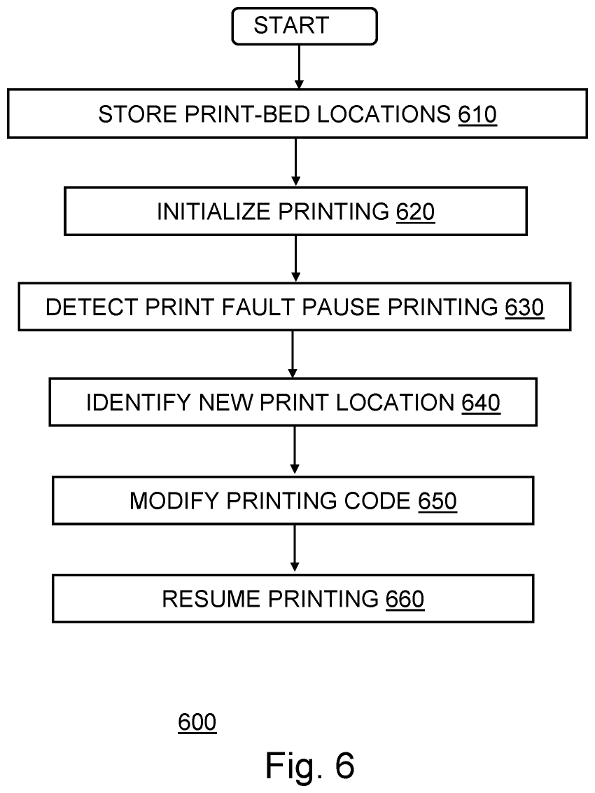

FIG. 6 provides a flowchart 600, illustrating exemplary activities associated with an embodiment of the invention. After program start at 610, methods store a set of possible print-bed locations for an object. The method may calculate the set may be calculated internally using a location selector or receive an externally calculated set provided to the system.

At 620, methods initialize printing a plurality of desired objects at the set of print-bed locations. Printing then proceeds for each layer of the multitude of layers of each of the plurality of objects.

At 630, methods detect a print fault for one object and pause the printing of the faulty object. In one embodiment, methods pause printing for all objects after detection of a print fault for one object. In one embodiment, methods utilize print fault detection modules as are known in the 3D printing arts to detect a failed printing.

At 640, methods identify a print-bed location for a new object from the set of print-bed locations using location selection criteria including overall print time and print-head collision avoidance.

At 650, methods modify the printing code, such as G-code, to remove the code for the first object and enable code for the new object. In one embodiment, methods utilize object offsets associated with print-bed locations for disabling the printing of the first object and enabling the printing of the new object.

At 660, methods resume printing to print the new object at the identified location. In one embodiment, methods print the new object to a level where printing the plurality of objects paused, then resume printing all remaining objects of the plurality of objects, other than the first object, and including the new object.

It is to be understood that although this disclosure includes a description on cloud computing, implementation of the teachings recited herein are not limited to a cloud computing environment. Rather, embodiments of the present invention are capable of being implemented in conjunction with any other type of computing environment now known or later developed.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, or media, as those terms are used in the present disclosure, explicitly excludes storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage medium or device as transitory because the data is not transitory while it is stored.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions collectively stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following clauses relate to aspects of one or more embodiments of the invention.

Clause 1. A computer implemented method for three-dimensionally (3D) printing a plurality of objects, the method including storing a set of candidate print-bed locations for each object of a plurality of objects, initializing printing of each object of the plurality of objects, detecting a printing failure for a first object of the plurality of objects, and pausing the printing of the first object. The method also includes identifying a first print-bed location for a new object from the set of candidate print bed locations, modifying print code adding instructions to print the new object at the first print-bed location, and printing the new object at the first print-bed location.

Clause 2. The method of clause 1 further including pausing the printing of all objects of the plurality of objects at an end of a first current layer after detecting the printing failure for the first object, designating the first current layer as a resume layer, printing the new object until a current layer of the new object equals the resume layer of the plurality of objects, and resuming the printing of the plurality of objects other than the first object.

Clause 3. The method according to clause 1 or clause 2, further including defining an offset for each object of the plurality of objects, disabling an offset of the first object, and enabling a new offset for the new object. Each offset is associated with a print-bed location of an object.

Clause 4. The method according to any one of clauses 1-3, further including determining a maximum number of print-bed locations for an object, receiving user input a quantity of objects in the plurality of objects, and providing a number of print-bed locations equal to the quantity.

Clause 5. The method according to any of the preceding clauses, further including printing the new object until a current layer of the new object equals a last layer.

Clause 6. The method according to any of the preceding clauses, further including selecting an initial print-bed location for an initial object of the plurality of objects, defining an offset from the initial print-bed location for each object of the plurality other than the initial object, and initializing the printing of each object of the plurality of objects according to the initial print-bed locations and the offsets.

Clause 7. The method according to any of the preceding clauses, further including identifying the first print-bed location according to a criterion selected from a list consisting of: first print-bed location will not cause a print-head collision, first print-bed location will minimize print time, first print-bed location is randomly selected, and combinations thereof.

Clause 8. A computer program product for three-dimensionally (3D) printing a plurality of objects, the computer program product comprising one or more computer readable storage media and collectively stored program instructions on the one or more computer readable storage media, the stored program instructions which, when executed, cause one or more computer systems to: store a set of candidate print-bed locations for each object of a plurality of objects, initialize printing of each object of the plurality of objects, detect a printing failure for a first object of the plurality of objects, pause printing of the first object, identify a first print-bed location for a new object from the set of candidate print bed locations, modify print code adding instructions to print the new object at the first print-bed location, and print the new object at the first print-bed location.

Clause 9. The computer program product according to clause 8, the computer program instructions further causing the one or more processors to: pause the printing of all objects of the plurality of objects at an end of a first current layer after detecting the printing failure for the first object, designate the first current layer as a resume layer, print the new object until a current layer of the new object equals the resume layer of the plurality of objects, and resume the printing of the plurality of objects other than the first object.

Clause 10. The computer program product according to either of clause 8 or

clause 9, the computer program instructions further causing the one or more processors to: define an offset for each object of the plurality of objects, disable an offset of the first object, and enable a new offset for the new object. Each offset is associated with a print-bed location of an object.

Clause 11. The computer program product according to any of clauses 8 to 10, the computer program instructions further causing the one or more processors to: determine a maximum number of print-bed locations for an object, receive user input a quantity of objects in the plurality of objects, and provide a number of print-bed locations equal to the quantity.

Clause 12. The computer program product according to any of clauses 8 to 11, the computer program instructions further causing the one or more processors to: print the new object until a current layer of the new object equals a last layer.

Clause 13. The computer program product according to any of clauses 8 to 12, the computer program instructions further causing the one or more processors to: select an initial print-bed location for an initial object of the plurality of objects, define an offset from the initial print-bed location for each object of the plurality other than the initial object, and initialize the printing of each object of the plurality of objects according to the initial print-bed locations and the offsets.

Clause 14. The computer program product according to any of clauses 8 to 13, the computer program instructions further causing the one or more processors to: identify the first print-bed location according to a criteria selected from a list consisting of: first print-bed location will not cause a print-head collision, first print-bed location will minimize print time, first print-bed location is randomly selected, and combinations thereof.

Clause 15. A computer system for three-dimensionally printing a plurality of objects, the computer system including: one or more computer processors, one or more computer readable storage media, and stored program instructions on the one or more computer readable storage media for execution by the one or more computer processors, the stored program instructions which, when executed, cause the one or more computer processors to: store a set of candidate print-bed locations for each object of a plurality of objects, initialize printing of each object of the plurality of objects, detect a printing failure for a first object of the plurality of objects, pause printing of the first object, identify a first print-bed location for a new object from the set of candidate print bed locations, modify print code adding instructions to print the new object at the first print-bed location, and print the new object at the first print-bed location.

Clause 16. The computer system according to clause 15, the computer program instructions further causing the one or more processors to: pause the printing of all objects of the plurality of objects at an end of a first current layer after detecting the printing failure for the first object, designate the first current layer as a resume layer, print the new object until a current layer of the new object equals the resume layer of the plurality of objects, and resume the printing of the plurality of objects other than the first object.

Clause 17. The computer system according to clause 15 or clause 16, the computer program instructions further causing the one or more processors to: define an offset for each object of the plurality of objects, disable an offset of the first object; and enable a new offset for the new object, wherein each offset is associated with a print-bed location of an object.

Clause 18. The computer system according to any of clauses 15-17, the computer program instructions further causing the one or more processors to: determine a maximum number of print-bed locations for an object, receive user input a quantity of objects in the plurality of objects, and provide a number of print-bed locations equal to the quantity.

Clause 19. The computer system according to any of clauses 15-18, the computer program instructions further causing the one or more processors to: select an initial print-bed location for an initial object of the plurality of objects, define an offset from the initial print-bed location for each object of the plurality other than the initial object, and initialize the printing of each object of the plurality of objects according to the initial print-bed locations and the offsets.

Clause 20. The computer system according to any of clauses 15-19, the computer program instructions further causing the one or more processors to: identify the first print-bed location according to a criterion selected from a list consisting of: first print-bed location will not cause a print-head collision, first print-bed location will minimize print time, first print-bed location is randomly selected, and combinations thereof.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for three-dimensionally (3D) printing a plurality of objects, the method comprising:
storing, by one or more computer processors, a set of candidate print-bed locations for each object of a plurality of objects;
initializing, by the one or more computer processors, printing of each object of the plurality of objects;
detecting, by the one or more computer processors, a printing failure for a first object of the plurality of objects;
pausing, by the one or more computer processors, the printing of the first object;
identifying, by the one or more computer processors, a first print-bed location for a new object from the set of candidate print bed locations;
modifying, by the one or more computer processors, print code adding instructions to print the new object at the first print-bed location; and
printing the new object at the first print-bed location.

2. The computer implemented method according to claim 1, further comprising:
pausing, by the one or more computer processors, printing of the plurality of objects at an end of a first current layer after detecting the printing failure for the first object;
designating, by the one or more computer processors, the first current layer as a resume layer of the plurality of objects;
printing the new object until a current layer of the new object equals the resume layer of the plurality of objects; and
resuming printing of the plurality of objects other than the first object.

3. The computer implemented method according to claim 1, further comprising:
defining, by the one or more computer processors, an offset for each object of the plurality of objects;
disabling, by the one or more computer processors, an offset of the first object; and
enabling, by the one or more computer processors, a new offset for the new object;
wherein each offset is associated with a print-bed location of an object.

4. The computer implemented method according to claim 1, further comprising:
determining, by the one or more computer processors, a maximum number of print-bed locations for an object;
receiving, by the one or more computer processors, user input a quantity of objects in the plurality of objects; and
providing, by the one or more computer processors, a number of print-bed locations equal to the quantity.

5. The computer implemented method according to claim 1, further comprising printing the new object until a current layer of the new object equals a last layer.

6. The computer implemented method according to claim 1, further comprising selecting, by the one or more computer processors, an initial print-bed location for an initial object of the plurality of objects;
defining, by the one or more computer processors, an offset from the initial print-bed location for each object of the plurality other than the initial object; and
initializing, by the one or more computer processors, printing of each object of the plurality of objects according to the initial print-bed locations and the offsets.

7. The computer implemented method according to claim 1, further comprising identifying, by the one or more computer processors, the first print-bed location according to a criterion selected from a list consisting of: first print-bed location will not cause a print-head collision, first print-bed location will minimize print time, first print-bed location is randomly selected, and combinations thereof.

8. A computer program product for three-dimensionally (3D) printing a plurality of objects, the computer program product comprising one or more computer readable storage media and collectively stored program instructions on the one or more computer readable storage media, the stored program instructions which, when executed, cause one or more computer systems to:
store a set of candidate print-bed locations for each object of a plurality of objects;
initialize printing of each object of the plurality of objects;
detect a printing failure for a first object of the plurality of objects;
pause printing of the first object;
identify a first print-bed location for a new object from the set of candidate print bed locations;
modify print code adding instructions to print the new object at the first print-bed location; and
print the new object at the first print-bed location.

9. The computer program product according to claim 8, the computer program instructions further causing the one or more processors to:
pause the printing of all objects of the plurality of objects at an end of a first current layer after detecting the printing failure for the first object;
designate the first current layer as a resume layer of the plurality of objects;
print the new object until a current layer of the new object equals the resume layer of the plurality of objects; and
resume the printing of the plurality of objects other than the first object.

10. The computer program product according to claim 8, the computer program instructions further causing the one or more processors to:
define an offset for each object of the plurality of objects;
disable an offset of the first object; and
enable a new offset for the new object;
wherein each offset is associated with a print-bed location of an object.

11. The computer program product according to claim 8, the computer program instructions further causing the one or more processors to:
determine a maximum number of print-bed locations for an object;
receive user input a quantity of objects in the plurality of objects; and
provide a number of print-bed locations equal to the quantity.

12. The computer program product according to claim 8, the computer program instructions further causing the one or more processors to print the new object until a current layer of the new object equals a last layer.

13. The computer program product according to claim 8, the computer program instructions further causing the one or more processors to: select an initial print-bed location for an initial object of the plurality of objects;
define an offset from the initial print-bed location for each object of the plurality other than the initial object; and
initialize the printing of each object of the plurality of objects according to the initial print-bed locations and the offsets.

14. The computer program product according to claim 8, the computer program instructions further causing the one or more processors to: identify the first print-bed location according to a criterion selected from a list consisting of: first print-bed location will not cause a print-head collision, first print-bed location will minimize print time, first print-bed location is randomly selected, and combinations thereof.

15. A computer system for three-dimensionally printing a plurality of objects, the computer system comprising:
one or more computer processors;
one or more computer readable storage media; and
stored program instructions on the one or more computer readable storage media for execution by the one or more computer processors, the stored program instructions which, when executed, cause the one or more computer processors to:
store a set of candidate print-bed locations for each object of a plurality of objects;
initialize printing of each object of the plurality of objects;
detect a printing failure for a first object of the plurality of objects;
pause printing of the first object;
identify a first print-bed location for a new object from the set of candidate print bed locations;
modify print code adding instructions to print the new object at the first print-bed location; and
print the new object at the first print-bed location.

16. The computer system according to claim 15, the computer program instructions further causing the one or more processors to:
pause the printing of all objects of the plurality of objects at an end of a first current layer after detecting the printing failure for the first object;
designate the first current layer as a resume layer of the plurality of objects;
print the new object until a current layer of the new object equals the resume layer of the plurality of objects; and
resume the printing of the plurality of objects other than the first object.

17. The computer system according to claim 15, the computer program instructions further causing the one or more processors to:
define an offset for each object of the plurality of objects;
disable an offset of the first object; and
enable a new offset for the new object;
wherein each offset is associated with a print-bed location of an object.

18. The computer system according to claim 15, the computer program instructions further causing the one or more processors to:
determine a maximum number of print-bed locations for an object;
receive user input a quantity of objects in the plurality of objects; and
provide a number of print-bed locations equal to the quantity.

19. The computer system according to claim 15, the computer program instructions further causing the one or more processors to:
select an initial print-bed location for an initial object of the plurality of objects;
define an offset from the initial print-bed location for each object of the plurality other than the initial object; and
initialize the printing of each object of the plurality of objects according to the initial print-bed locations and the offsets.

20. The computer system according to claim 15, the computer program instructions further causing the one or more processors to: identify the first print-bed location according to a criterion selected from a list consisting of: first print-bed location will not cause a print-head collision, first print-bed location will minimize print time, first print-bed location is randomly selected, and combinations thereof.
